(19) United States
(12) Patent Application Publication
(10) Pub. No.: US 2026/0307533 A1
(43) Pub. Date: Oct. 8, 2026

(54) BATTERY ENERGY AND POWER INDICATOR SYSTEM

(71) Applicant: BETA AIR LLC, South Burlington, VT (US)

(72) Inventors: Cullen Jemison, Winooski, VT (US); Steven J. Foland, Garland, TX (US)

(21) Appl. No.: 19/636,804

(22) Filed: Apr. 1, 2026

Related U.S. Application Data
(60) Provisional application No. 63/784,469, filed on Apr. 7, 2025.

(51) Int. Cl. B60L 58/16; B64D 27/357; B64D 45/00; H01M 10/48; H01M 50/249

(52) U.S. Cl. CPC B60L 58/16; B64D 27/357; B64D 45/00; H01M 10/482; H01M 10/488; H01M 50/249; B60L 2200/10; B60L 2240/26; B60L 2250/16; B64D 2045/0085; H01M 2220/20

(57) ABSTRACT

Systems and techniques for providing an energy requirement determination and indication system to an aircraft. The systems and techniques may include battery pack(s), battery sensor(s) configured to detect battery data, processor(s) and memory. The memory may contain instructions that configure the processor(s) to receive the battery data from the battery sensor(s); determine energy data based on the battery data; determine, based on the energy data and the battery data, an energy threshold value of a category of flight; and generate a display comprising visual representations of the battery data and the energy threshold value.

### CROSS REFERENCE TO RELATED APPLICATION

This application claims priority to U.S. Provisional Application No. 63/784,469, filed Apr. 7, 2025, the entire disclosure of which is incorporated herein by reference.

### BACKGROUND

Electric aircrafts or hybrid aircrafts are an emerging technology. The aircrafts may store energy on board in high voltage batteries which may help power an electric or hybrid engine, as well as other systems of the aircraft. Accurately displaying energy information is a challenge and existing techniques are insufficient.

### SUMMARY

In some examples, the systems and techniques described herein provide energy determination and display of power requirements of an aircraft.

In some examples, the systems and techniques described herein relate to a system that may determine an energy requirement of an aircraft and present a dynamic display. In accordance with some of the techniques described herein, the system may include at least one battery pack, at least one battery sensor, at least one processor, and a memory communicatively connected to the at least one processor. The at least one battery sensor may be communicatively connected to the at least one battery pack and configured to detect battery data. The memory may contain instructions configuring the at least one processor to perform one or more operations of the system. For instance, the operations may include receive the battery data from the at least one battery sensor. The at least one processor may determine an energy datum based on the battery data. The at least one processor may determine, based on the energy datum and the battery data, an energy threshold value of a category of flight. The at least one processor may generate a display comprising visual representations of the battery data and the energy threshold value.

In an example, the systems and techniques described herein relate to method for energy requirement determination of an aircraft. The method may comprise detecting, by a battery sensor communicatively connected to a battery pack, battery data. The method may include receiving, by a processor, the battery data from the battery sensor. The method further includes determining, by the processor, an energy data based on the battery data. The method also includes determining, by the processor and based on the energy data and the battery data, an energy threshold value of a category of flight. The method also includes generating, by the processor, a display comprising visual representations of the battery data and the energy threshold value.

In an example, the category of flight comprises thrust born flight or wing born flight. In some examples, the at least one battery pack comprises a plurality of battery packs; and the display further comprises a battery meter comprising a plurality of segments, wherein each segment of the plurality of segments corresponds to a battery pack of the plurality of battery packs. In an example, the display further comprises a battery meter and a flight category threshold associated with the category of flight. In an example, the system or method may determine a second energy threshold value of the category of flight.

In some examples, the energy threshold value is dynamic and determined based on one or more capabilities of the at least one battery pack, the one or more capabilities corresponding to a state of health of the at least one battery pack. For instance, the energy data may comprise a useable energy remaining data, wherein the useable energy remaining data is based on the one or more capabilities of the at least one battery pack or a power level associated with the state of health of the at least one battery pack. In an example, the energy threshold value is further based in part on a mode of flight of the aircraft, the mode of flight being one of a plurality of modes of flight, and wherein each respective mode of flight corresponds to a respective level of power consumption.

In an example, the system or method may receive weather data; and determine the energy threshold value based on the weather data. Additionally or alternatively, the system or method may receive weight data; and determine the energy threshold value based on the weight data.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 depicts an example of an aircraft implementing a system for energy requirement determination, according to at least one example.

FIG. 2 depicts an example process for generating data that may be output and displayed by the power determination system, according to at least one example.

FIGS. 3A and 3B depict an example pilot interface implementing components of the power determination system, according to examples described herein.

FIGS. 4A and 4B depict exemplary display elements, according to at least one example.

FIGS. 5A and 5B depict exemplary display elements, according to at least one example.

FIG. 6 depicts a flow diagram of an example system for power determination and indication, according to the techniques described herein.

FIG. 7 depicts an exemplary embodiment of a flight controller, according to at least one example.

FIG. 8 depicts a diagrammatic representation of one embodiment of a computing device in the exemplary form of a computer system within which a set of instructions for causing a control system to perform any one or more of the aspects and/or methodologies of the present disclosure may be executed.

### DETAILED DESCRIPTION

The present description provides systems and techniques related to operating an aircraft, such as an electric aircraft or a hybrid aircraft. An example of an electric aircraft that may operate in accordance with the techniques described herein is a thrust born flight aircraft or a wing born flight aircraft. However, a person of ordinary skill in the relevant technology will recognize that other types of aircrafts and vehicles (e.g., cars) may use the techniques described herein.

In some examples, the systems and techniques described herein relate to a system that may determine an energy requirement of an aircraft and present a dynamic display. In accordance with some of the techniques described herein, the system may include at least one battery pack, at least one battery sensor, at least one processor, and a memory communicatively connected to the at least one processor. The at least one battery sensor may be communicatively connected to the at least one battery pack and configured to detect battery data. The memory may contain instructions configuring the at least one processor to perform one or more operations of the system. For instance, the operations may include receive the battery data from the at least one battery sensor. The at least one processor may determine an energy datum based on the battery data. The at least one processor may determine, based on the energy datum and the battery data, an energy threshold value of a category of flight. The at least one processor may generate a display comprising visual representations of the battery data and the energy threshold value.

In an example, the systems and techniques described herein relate to a method for energy requirement determination of an aircraft. The method may comprise detecting, by a battery sensor communicatively connected to a battery pack, battery data. The method may include receiving, by a processor, the battery data from the battery sensor. The method further includes determining, by the processor, an energy data based on the battery data. The method also includes determining, by the processor and based on the energy data and the battery data, an energy threshold value of a category of flight. The method also includes generating, by the processor, a display comprising visual representations of the battery data and the energy threshold value.

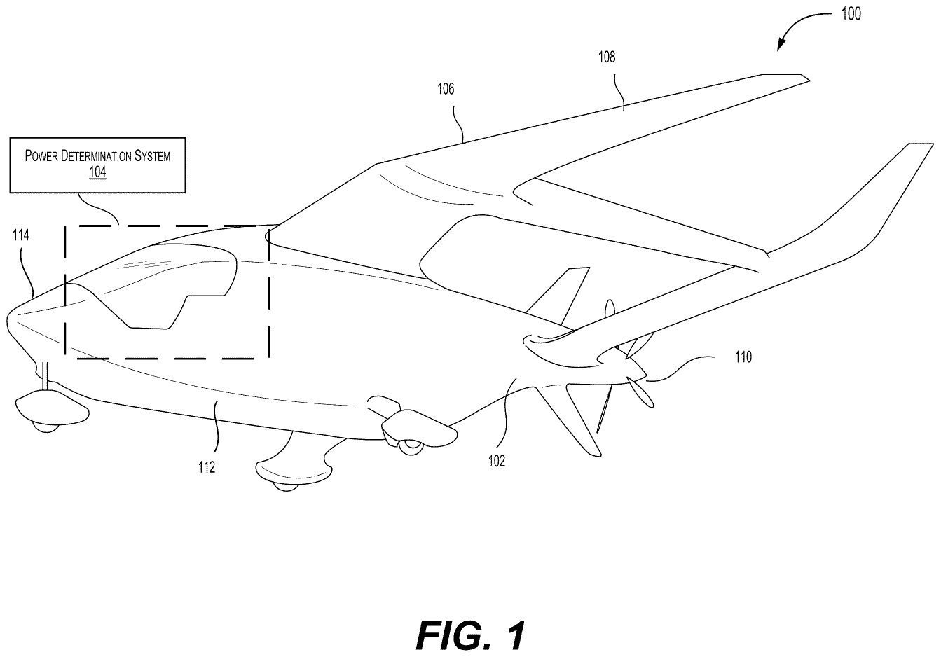

Turning now to the figures, FIG. 1 depicts an example of an aircraft 100 implementing a system for energy requirement determination, according to at least one example. The aircraft 100 may include a wing born flight aircraft or a thrust born flight aircraft. In an example, a wing born flight aircraft may hover, take-off, and land vertically. An electric aircraft, as used herein, is an electrically powered aircraft typically using an energy source, or a plurality of energy sources, to power the aircraft. In order to optimize the power and energy necessary to propel the aircraft, aircraft 100 may be capable of rotor-based cruising flight, rotor-based take-off, rotor-based landing, fixed-wing cruising flight, airplane-style take-off, airplane-style landing, and/or any combination thereof. Rotor-based flight, as described herein, is where the aircraft generates lift and propulsion by way of one or more powered rotors coupled with an engine, such as a multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight. In an example, the aircraft 100 may be configured to perform wing born flight. In an example, wing born flight may include horizontal take-off and landing and/or a conventional take-off and landing. While the example illustrated in FIG. 1 describes an aircraft 100, it is understood that the systems and mechanisms described herein may apply to any aircraft, hybrid aircraft, or other similar vehicle.

The aircraft 100 includes a fuselage 102 with wings 108 extending from the fuselage 102. The wings 108 may include airfoil shapes and support booms that extend along a direction parallel with a length of the fuselage 102 and include lift propulsors 106 to provide lift and propulsion for the electric aircraft. The aircraft 100 also includes a propulsor 110 for forward propulsion as well as stabilizers. The wings 108 and stabilizers may provide control surfaces for controlling the attitude of the fuselage 102 during flight.

Propulsors 106 may provide vertical propulsion. Propulsor 110 may be positioned at a rear of the fuselage 102 and propel the aircraft forward. A lift propulsor is a propulsor 106 that generates lift to propel the aircraft in an upward direction; one of more lift propulsors may be mounted on the front, on the wings 108, at the rear, and/or any suitable location. A propulsor 106, as used herein, is any component or device used to propel a craft by exerting force on a fluid medium, which may include a gaseous medium such as air or a liquid medium such as water. At least a lift propulsor is a propulsor 106 that generates a substantially downward thrust, tending to propel the aircraft 100 in a vertical direction providing thrust for maneuvers such as without limitation, wing born take-off, wing born landing, hovering, and/or rotor-based flight, thrust born take-off, thrust born landing, or similar styles of flight.

While shown as a single propulsor at the rear, the propulsor 110 is for propelling an aircraft in a forward direction and may include one or more propulsors mounted on the front, on the wings, at the rear, or a combination of any such positions. At least a forward propulsor may propel the aircraft 100 forward for fixed-wing and/or “airplane”-style flight, take-off, and/or landing, and/or may propel the aircraft 100 forward or backward on the ground. The propulsors 106 and the propulsor 110 include a thrust element that may include any device or component that converts the mechanical energy of a motor, for instance in the form of rotational motion of a shaft, into thrust in a fluid medium. The thrust element may include, without limitation, a device using moving or rotating foils, including without limitation one or more rotors, an airscrew or propeller, a set of airscrews or propellers such as contrarotating propellers, a moving or flapping wing, or the like. The thrust element may include, in some examples, a marine propeller or screw, an impeller, a turbine, a pump-jet, a paddle or paddle-based device, or the like.

Propulsors 106 and/or propulsor 110 may include at least a motor mechanically coupled to the thrust element. The motor may include without limitation, any electric motor, where an electric motor is a device that converts electrical energy into mechanical energy, for instance by causing a shaft to rotate. The motor may be driven by direct current (DC) electric power; for instance, at least a first motor may include a brushed DC at least a first motor, or the like. The motor may also be driven by electric power having varied, or reversing, voltage levels such as alternating current (AC) power as produced by an alternating current generator and/or inverter, or otherwise varying power, such as produced by a switching power source. The propulsors 106 and the propulsor 110 may be coupled to a controller area network (CAN) bus. The CAN bus enables the control units of the propulsors to communicate with a flight controller as well as with the other propulsors and/or other components coupled to the CAN bus.

As illustrated in FIG. 1, the aircraft 100 includes a power determination system 104. The power determination system 104 may include a computing device (e.g., such as a pilot interface), a flight controller, sensor(s) 114, and battery pack(s) 112.

The one or more battery pack(s) 112 may be housed within the fuselage 102. For the purposes of this disclosure, a “battery pack” is a source of electrical energy comprising a plurality of battery cells. As used herein, a “battery cell” is an electrochemical device configured to store electrical energy. Battery pack(s) 112 may include a plurality of battery cells. In an example, a battery pack 112 may include a battery, rechargeable battery, flow battery, glass battery, lithium-ion battery, ultrabattery, and the like thereof. In one or more embodiments, battery pack(s) 112 may have high power density where electrical power and power source can usefully produce per unit of volume and/or mass is relatively high.

As used in this disclosure, “electrical power” is a rate of electrical energy per unit time. A power source may include a device for which power that may be produced per unit of volume and/or mass has been optimized, for instance at an expense of maximal total specific energy density or power capacity. In one or more non-limiting exemplary embodiments, power source may include batteries used for starting applications including Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode, energy source may be used, in an embodiment, to provide electrical power to an electric aircraft or drone, such as an electric aircraft vehicle, during moments requiring high rates of power output, including without limitation take-off, landing, thermal de-icing and situations requiring greater power output for reasons of stability, such as high turbulence situations, as described in further detail below. A power source may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Persons skilled in the art, upon reviewing the entirety of this disclosure, will be aware of various devices of components that may be used as a power source.

In an example, a battery pack 112 may include a plurality of battery modules. For the purposes of this disclosure, a “battery module,” is a subset of battery cells within a battery pack. In some embodiments, each battery cell within a battery module may be connected to a module monitor unit. In an example, a battery pack 112 may include a battery management component. Battery management component may include a module monitor unit (MMU), a pack monitoring unit (PMU), and/or a high voltage disconnect. In one or more embodiments, Battery management component may also include a sensor. For example, and without limitation, Battery management component may include a sensor suite having a plurality of sensors. In one or more embodiments, battery management component includes MMU, may be mechanically connected and communicatively connected to battery pack 112. In one or more embodiments, MMU may be configured to detect a condition parameter of battery module of battery pack 112. For the purposes of this disclosure, a “condition parameter” is detected electrical or physical input and/or phenomenon related to a state of a battery pack. A state of a battery pack may include detectable information related to, for example, a temperature, a moisture level, a humidity, a voltage, a current, vent gas, vibrations, chemical content, or other measurable characteristics of battery pack 112 or components thereof, such as battery module and/or battery cell. For example, and without limitation, MMU may detect and/or measure a condition parameter, such as a temperature, of battery module. In one or more embodiments, a condition state of battery pack 112 may include a condition state of a battery module and/or battery cell. In one or more embodiments, MMU may include a sensor (e.g., such as one of sensor(s) 114), which may be configured to detect and/or measure condition parameter.

The sensor(s) 114 may include one or more battery sensor(s). In some embodiments, a battery sensor is communicatively connected to a battery pack 112. In some embodiments, a battery sensor may be communicatively connected to any battery modules, battery cells, or other components within battery pack 112. For the purposes of this disclosure, “battery sensor,” is a sensor configured to detect phenomena from a battery pack and/or components thereof. In an example, battery sensor is configured to detect battery data. “Battery data,” for the purposes of this disclosure, is data collected from a battery pack or components thereof. As a non-limiting example, battery data may be collected from one or more battery modules within a single battery pack and/or multiple battery packs 112. As a non-limiting example, battery data may be collected from one or more battery cells within a battery pack 112.

The computing device may include a display, processor(s), memory etc. In an example, the computing device may include, without limitation, one or more of a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include, be included in, and/or communicate with a flight controller. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail, such as via a network interface device. Network interface device may be utilized for connecting Computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

The flight controller may comprise one or more processor(s), memory, etc. Memory may contain instructions configuring processor(s) to perform actions consistent with this disclosure. Memory may be communicatively connected to processor(s). As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Sensor(s) 114 may be included as part of the power determination system 104. In an example, sensor(s) 114 may include a sensor suite which may include a plurality of sensors that may detect similar or unique phenomena. As used in this disclosure, a “sensor” is a device that is configured to detect an input and/or a phenomenon and transmit information and/or datum related to the detection. A sensor may generate a sensor output signal, which transmits information and/or datum related to a sensor detection. A sensor output signal may include any signal form described in this disclosure, for example digital, analog, optical, electrical, fluidic, and the like. In some cases, a sensor, a circuit, and/or a controller may perform one or more signal processing steps on a signal. For instance, a sensor, circuit, and/or controller may analyze, modify, and/or synthesize a signal in order to improve the signal, for instance by improving transmission, storage efficiency, or signal to noise ratio. In an example, sensor(s) 114 may include battery sensor(s), as described herein.

In a non-limiting embodiment, sensor suite may include a plurality of accelerometers, a combination of accelerometers and gyroscopes, or a combination of one or more of an accelerometer, gyroscope, pressure sensor, and/or torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings.

In an example, sensor(s) 114 may include a plurality of independent sensors, where any number of the described sensors may be used to detect any number of physical or electrical quantities associated with battery pack(s) 112 and/or any components therein. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of the sensor(s) 114 (e.g., such as battery sensor(s)) to detect phenomenon may be maintained.

Still referring to FIG. 1, battery sensor 120 may include a motion sensor. A “motion sensor”, for the purposes of this disclosure, refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor(s) 114 may include, torque sensor, gyroscope, accelerometer, torque sensor, magnetometer, inertial measurement unit (IMU), pressure sensor, force sensor, proximity sensor, displacement sensor, vibration sensor, among others.

In some embodiments, sensor(s) 114 may include a pressure sensor. A “pressure”, for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure an atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors or alone or in a combination thereof. The pressor sensor may include a barometer. In some embodiments, the pressure sensor may be used to indirectly measure fluid flow, speed, water level, and altitude. In some embodiments, a pressure sensor may be configured to transform a pressure into an analogue electrical signal. In some embodiments, the pressure sensor may be configured to transform a pressure into a digital signal.

In one or more embodiments, sensor(s) 114 may include a moisture sensor. “Moisture”, as used in this disclosure, is the presence of water, which may include vaporized water in air, condensation on the surfaces of objects, or concentrations of liquid water. Moisture may include humidity. “Humidity”, as used in this disclosure, is the property of a gaseous medium (almost always air) to hold water in the form of vapor.

In one or more embodiments, sensor(s) 114 may include electrical sensors. Electrical sensors may be configured to measure voltage across a component, electrical current through a component, and resistance of a component. In one or more embodiments, battery sensor 120 may include thermocouples, thermistors, thermometers, infrared sensors, resistance temperature sensors (RTDs), semiconductor based integrated circuits (ICs), a combination thereof, or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within a battery sensor, may be measured in Fahrenheit (° F.), Celsius (° C.), Kelvin (° K), or another scale alone or in combination. The temperature measured by sensors 114 may comprise electrical signals, which are transmitted to their appropriate destination wireless or through a wired connection.

In some embodiments, battery sensor 120 may include a plurality of sensing devices, such as, but not limited to, temperature sensors, humidity sensors, accelerometers, electrochemical sensors, gyroscopes, magnetometers, inertial measurement unit (IM), pressure sensor, proximity sensor, displacement sensor, force sensor, vibration sensor, air detectors, hydrogen gas detectors, and the like. Sensor(s) 114 and/or battery sensor(s) may be configured to detect a plurality of data, as discussed further below in this disclosure.

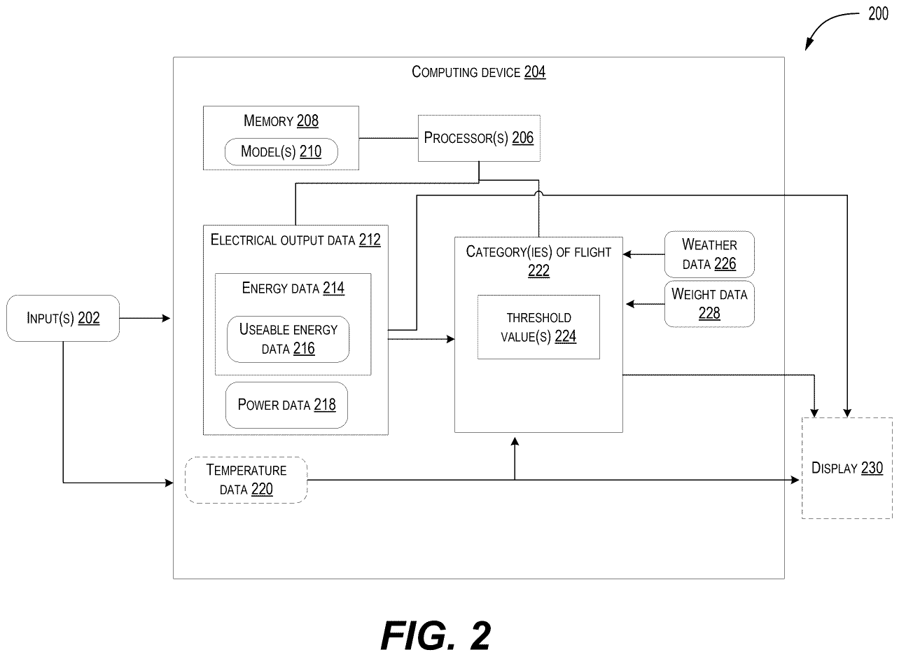

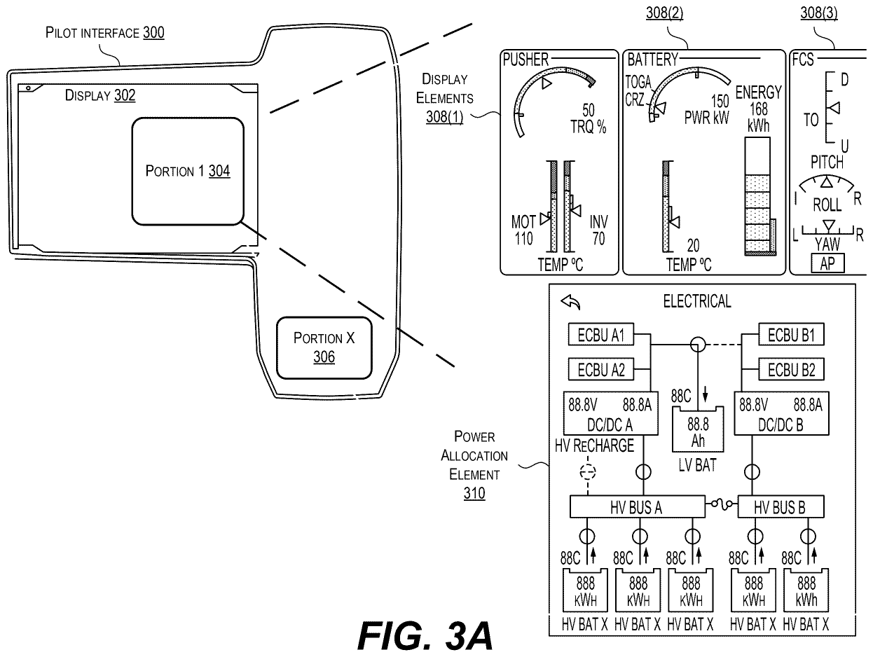

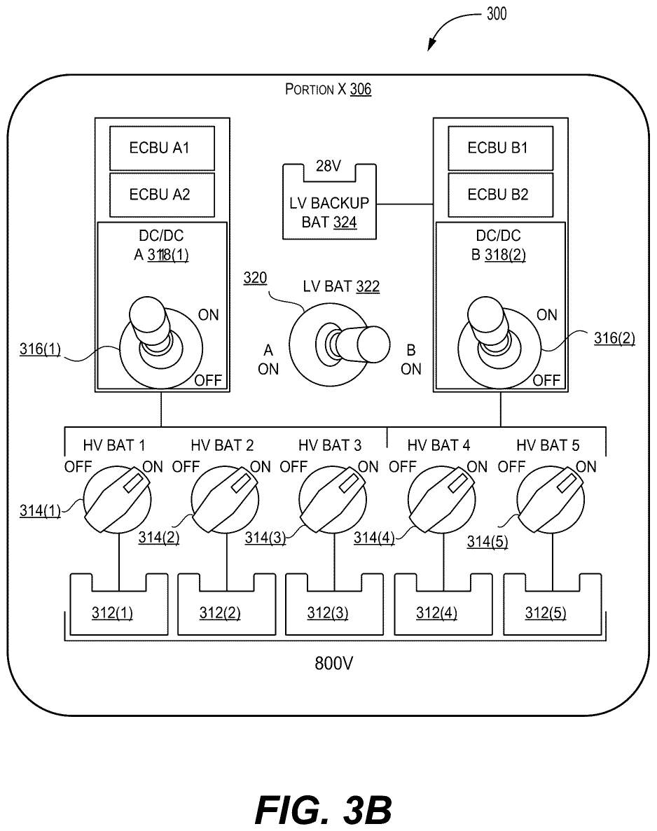

In an example, the processor(s) of the flight controller and/or computing device may be configured to receive input (e.g., battery data, sensor data, flight data, or any other type of data) from sensor(s) 114 and/or other components of the aircraft 100. The processor(s) may be configured to generate an interface for display via the computing device. As described in greater detail in FIGS. 2, 3A, and 3B below, the interface may comprise display element(s) and/or power allocation element(s) that may provide visual representations of real-time data associated with the aircraft 100. In an example, the display elements may include a plurality of visual representations corresponding to battery data, as described herein.

In an example, the processor(s) of the flight controller and/or computing device may be configured to receive input (e.g., battery data, sensor data, flight data, or any other type of data) from sensor(s) 114 and/or other components of the aircraft 100. The processor(s) may be configured to generate an interface for display via the computing device. As described in greater detail in FIGS. 2, 3A, and 3B below, the interface may comprise display element(s) and/or power allocation element(s) that may provide visual representations of real-time data associated with the aircraft 100. In an example, the display elements may include a plurality of visual representations corresponding to battery data, as described herein.

In an example and as described in greater detail in FIG. 2 below, the power determination system 104 may be configured to mitigate over reporting of usable energy available to the aircraft. For instance, the power determination system 104 may be configured to provide a more accurate determination of usable energy available to the aircraft. The usable energy may be based on battery health considerations (e.g., capacity face, power capability fade, retirement of the battery due to safety precautions, etc.) indicated by battery datum.

FIG. 2 illustrates an example process 200 for generating data that may be output and displayed by the power determination system 104, according to at least one example. In an example, the process 200 may be performed by one or more processor(s) of a computing device 204, a flight controller, or any other device described herein. As illustrated, the computing device 204 may receive input(s) 202. In an example, the input(s) 202 may comprise signal(s), a power demand, battery data, or any other data described herein. In an example, battery data (e.g., input(s) 202) may comprise power data 218. “Power data,” for the purposes of this disclosure comprises data representing the rate at which electric energy is output by a battery pack 112 or components thereof. In some embodiment, processor(s) 206 may be configured to determine power data 218 based on the input(s) 202. As a non-limiting example, the processor(s) 206 may determine the power data 218 based on multiplying a current datum with a voltage drop of the load connected to battery pack 112. Persons of ordinary skill in the art, having reviewed the entirety of this disclosure, would appreciate that a variety of methods may be suitable for determining power data 218. In some examples, the power data 218 may be included as part of the electrical output data 212 generated by the computing device 204.

In an example, input(s) 202 may comprise temperature data 220. “Temperature data,” for the purposes of this disclosure, is a datum relating to the temperature of battery pack 112 or any components thereof. In some embodiments, battery data may include battery temperature data 220. As a non-limiting example, an elevated battery temperature value may result in a higher energy value below which the aircraft can no longer support a vertical transition out of landing or energy value below which the aircraft can no longer support a rejected landing. As a non-limiting example, this may be due to the fact that propulsor may need to be run at a lower threshold to avoid over heating battery pack 112, resulting in a longer and less energy efficient maneuver.

In an example, the processor(s) 206 may be configured to may perform one or more signal processing steps on a signal (e.g., such as signal(s) received from sensor(s) 114, flight component(s), flight controller, etc.). For instance, the processor(s) 206 may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

In an example, the input(s) may be received from one or more battery pack(s) 112. In an example, a battery pack 112 may be represented as an ideal voltage source in series with an impedance (e.g., these types of models are known as equivalent circuit models. Another common model being physiochemical models that are physical in nature involving concentrations and reaction rates). This impedance may be termed internal resistance of source.

In an example, when battery pack 112 delivers power, a measured voltage output may be lower than a no-load voltage; difference voltage between loaded and unloaded voltage (estimable as product of current and resistance) may be caused by internal resistance. In practice, internal resistance of a battery is dependent on its size, state of charge, chemical properties, age, temperature, and discharge current. Battery pack 112 may have an electronic component due to resistivity of battery pack 112 materials and an ionic component due to electrochemical factors such as electrolyte conductivity, ion mobility, speed of electrochemical reaction and electrode surface area. Measurement of internal resistance of a battery pack 112, module, or cell may be a guide to its condition, but may not apply at other than test conditions. For instance, measurement with an alternating current, typically at a frequency of 1 kHz, may underestimate resistance, as the frequency may be too high to take into account slower electrochemical processes. Internal resistance may depend on temperature; for example, a fresh Energizer E91 AA alkaline primary battery drops from about 0.9Ω at −40° C., when the low temperature reduces ion mobility, to about 0.15Ω at room temperature and about 0.1Ω at 40° C. In some cases, a large part of this drop may be due to increase in magnitude of electrolyte diffusion coefficient. Internal resistance of a battery may be calculated from its open circuit voltage V_{NL}, load voltage V_{FL}, and the load resistance R_{L}:

$${R}_{int} = ( \frac{{V}_{NL}}{{V}_{FL}} - 1 ) {R}_{L}$$

Internal losses may also be expressed in terms of the Overpotential l and the current I:

$${R}_{int} = \frac{η}{I}$$

Internal resistance, i.e., internal losses, of a battery pack 112 may be measured using equivalent series resistance (ESR) meters, essentially AC milliohm-meters normally used to measure the ESR of capacitors. In some cases, internal resistance measurement may be used to estimate a state of discharge, i.e. state of charge, of a battery and/or battery pack 112. In use, voltage across terminals of a battery and/or battery pack 112 driving a load decreases until it drops too low to be useful; in some cases, this is largely due to an increase in internal resistance rather than a drop in the voltage of the equivalent source. In some rechargeable lithium polymer batteries, internal resistance may be largely independent of state of charge but increases as the battery ages due to a buildup of a passivation layer on electrodes. Thus, in some cases, measured internal losses may provide a more reliable indication of expected life or state of health of a battery or battery pack 112.

In some cases, battery and/or battery pack parameters may be estimated by the processor(s) 206 and/or with a measured open-circuit voltage. Open-circuit voltage may be the difference of electrical potential between two terminals of an electronic device when disconnected from any circuit, i.e., when there is no external load connected and no external electric current flows between the terminals. Alternatively or additionally, open-circuit voltage may be considered as voltage that must be applied to a battery to stop current. Open-circuit voltage may be referred to as Thevenin voltage. Open-circuit voltages of batteries may be considered under particular conditions (e.g., state-of-charge, illumination, temperature, etc.).

In an example, the processor(s) 206 may be configured to determine electrical output data 212. An “electrical output data,” for the purposes of this disclosure, is data regarding the electrical output of a battery pack or components thereof. In some embodiments, electrical output data 212 may include an energy data 214 as described herein.

In some embodiments, processor(s) 206 and/or circuit may be configured to generate energy data 214 as a function of input(s) 202 (e.g., such as battery data). For the purposes of this disclosure, “energy data” is data relating to the energy content or capacity of a battery pack or components thereof. As non-limiting examples, energy may be measured in Joules, kilo-Joules, kilowatt-hour, watt-hour, calories, kilo-calories, and the like. In some embodiments, energy data 214 may include a state of charge (SoC) of battery pack(s) 112. As a non-limiting example, SoC may include an energy remaining in battery pack(s) 112 divided by a total energy capacity of battery pack 112. In some embodiments, SoC may be expressed as a percentage.

The processor(s) and/or circuit may be configured to generate energy data 214 using a voltage datum from input(s) 202 (e.g., such as battery data). In some embodiments, generating energy data 214 using voltage datum may include using a look up table. A “look up table” is an array in computer science that replaces runtime computation with a simpler array indexing operation. Lookup tables may be used to validate input values by matching them against a list of valid or invalid items in an array. Lookup table may also hold static data and is used to look up a secondary value based on a primary value. As a non-limiting example, look up table may include an energy look up table. For the purposes of this disclosure, an “energy look up table,” is a look up table that relates one or more parameters to an energy remaining of a battery pack. As a non-limiting example, the processor(s) 206 may look up voltage datum from input(s) 202 (e.g., such as battery data) in energy look up table to find energy data 214.

Processor(s) 206 may be configured to determine useable energy data 216. In some examples, useable energy data 216 may be determined based on determining unusable energy data and subtracting the unusable energy data value from energy data 214 (e.g., representing the energy remaining in battery pack 112). In an example, the useable energy remaining data is based on the one or more capabilities of the at least one battery pack or a power level associated with the state of health of the at least one battery pack. For instance, the power level associated with a new battery may correspond to a higher value compared to the power level of a battery that is months and/or years old.

Thus, the determination of useable energy remaining may provide improved understanding of how much energy is remaining until the aircraft can no longer sustain flight. Accordingly, techniques described herein may provide a more accurate way to determine and display useable energy, thereby increasing safety and efficiency of an aircraft.

In an example, the processor(s) 206 may determine unusable energy data as a function of weight data 228. For the purposes of this disclosure, a “weight data” is a datum regarding the weight of an aircraft. In some embodiments, weight data 228 may include a weight of aircraft at take-off. In some embodiments, weight data 228 may include a current weight of an aircraft. In some embodiments, weight data 228 may be received by processor 206 from a weight sensor. Weight sensor may include a scale(s), load cell(s), weighing platform(s), and the like. As a non-limiting example, a greater weight data 228 may result in a need for a greater lift to be generated in order to sustain conventional flight. Greater lift may necessitate a greater airspeed, as the velocity of air over the wings of the aircraft is related to the amount of lift generated by wings of the aircraft. Greater airspeed may require more thrust from a propulsor, which requires more energy. Thus, a higher value of weight data 228 may result in a higher amount of unusable energy. As a non-limiting example, a lesser weight data 228 may result in a need for a less lift to be generated in order to sustain conventional flight. A lower lift requirement may allow for a lower airspeed, as the velocity of air over the wings of the aircraft is related to the amount of lift generated by wings of the aircraft. Lower airspeed may allow for less thrust from a propulsor, which allows for less energy. Thus, a lower weight data 228 may result in a lower unusable energy data. As a non-limiting example, a greater weight data 228 may result in a need for a greater lift to be generated in order to sustain hover. Greater lift may require greater lift from lift propulsors. Greater lift from lift propulsors may require lift propulsors to consume more energy. Thus, a higher weight data 228 may result in a higher unusable energy data. As a non-limiting example, a lower weight data 228 may result in a need for a less lift to be generated in order to sustain hover. Less lift may require less lift from lift propulsors. Less lift required from lift propulsors may require lift propulsors to consume less energy. Thus, a lower weight data 228 may result in a lower unusable energy data.

In an example, processor(s) 206 may determine unusable energy data as a function of a weather data 226. For the purposes of this disclosure, a “weather data” is a datum regarding an actual or forecasted weather condition. As non-limiting examples, weather condition may include wind speed, wind direction, humidity, pressure, chance of rain, precipitation, and the like. In some embodiments, processor 206 may receive weather data 226 from a weather sensor. As used in this disclosure, a “weather sensor” may include any sensor configured to detect, sense and/or measure a weather data 226 in an environment exterior to aircraft. For example, and without limitation, weather sensor may be configured to detect the temperature, humidity, pressure, air or wind speed and/or direction, moisture content, fog level, and the like, and may include, without limitation, an inertial measurement unit (IMU), gyroscope, temperature sensor, proximity sensor, pressure sensor, light sensor, air speed sensor, pitot tube, and the like. Weather sensor may include, without limitation, an all-in-one weather sensor which is configured to measure multiple parameters, such as, and without limitation, wind speed and direction, precipitation, barometric pressure, temperature, relative humidity, and the like among other parameters. In some embodiments, the at least a sensor includes a sensor external to the aircraft and located at or connected to an external source. For example, and without limitation, weather sensor may be at a weather service, airport, airplane, local tower, connected to the internet, and the like. In some embodiments, processor 206 may be configured to receive weather data 226 using an application programming interface (API). Processor 206 may be configured to query a weather API for current or forecasted weather at a location. In some embodiments, weather sensor may include an airspeed sensor. In some embodiments, weather sensor may include an airspeed sensor. An “air speed sensor” as used in this disclosure is any sensor configured to detect, sense and/or measure an air speed datum in an environment exterior to aircraft. For example, and without limitation, an air speed datum may include wind speed and/or direction. Air speed or wind sensors may include, without limitation, anemometers, pitot tubes, hot-wire sensors, laser doppler sensors, ultrasonic sensors, pressure sensors, and the like among others.

As a non-limiting example, weather data 226 may comprise indications that headwinds may result in a lower unusable energy data. Weather data 226 indicating headwinds would indicate that the airspeed of the wings of aircraft would be higher than if there were no headwinds. This increased airspeed over the wings would result in increased lift generated by the wings. Increased lift generated by the wings at a given airspeed of the aircraft may mean that less thrust from thrust propulsors is needed to sustain flight. Less thrust from thrust propulsors may mean less energy is required, thereby resulting in a lower unusable energy data. A weather data indicating tailwinds would indicate that the airspeed of the wings of aircraft would be lower than if there were no tailwinds. This decreased airspeed over the wings would result in decreased lift generated by the wings. Decreased lift generated by the wings at a given airspeed of the aircraft may mean that more thrust from thrust propulsors is needed to sustain flight. More thrust from thrust propulsors may mean more energy is required, thereby resulting in a higher amount of unusable energy data.

In some embodiments, unusable energy data may be updated by processor 206 before a flight of aircraft. As a non-limiting example, weight data 228 including take-off weight and/or a forecasted weather data 226 may be used to determine an unusable energy data. In some embodiments, processor 206 may update unusable energy data in real time; for example, using a weight datum and/or current weather data 226.

In an example, processor(s) 206 may be configured to determine one or more threshold value(s) 224 associated with one or more category(ies) of flight 222. A “category of flight,” for the purposes of this disclosure, is a mode of flight (e.g., vertical take-off and landing, conventional take-off and landing, cruising, wing born flight, thrust born flight, hover, etc.). In an example, each category of flight 222 may be associated with a different level of power consumption and/or a different threshold value 224. For instance, take-off may require a higher level of power consumption by the aircraft 100 compared to “cruising”.

In an example, threshold value(s) 224 may correspond to one or more energy threshold(s). As used herein, an “energy threshold,” is an energy value representing below which the functionality or ability of an electric aircraft may be compromised. In an embodiment, an energy threshold may include an energy value below which the aircraft can no longer support a rejected landing. A “rejected landing,” for the purposes of this disclosure is an attempted landing of an aircraft that is aborted. In an embodiment, energy threshold may include an energy value below which the aircraft can no longer support hover. In an embodiment, energy threshold may include an energy value below which the aircraft can no longer support level flight. A “go-around,” for the purposes of this disclosure is a procedure that an aircraft conducts after an aborted landing in order to conduct another approach. In an embodiment, energy threshold may include an energy value below which the aircraft can no longer support a go-around. In an embodiment, energy threshold may include an energy value below which the aircraft can no longer support level flight. For the purposes of this disclosure, “level flight” is a state of conventional flight, wherein the wing is deflected zero degrees from the surrounding flow of air. In an embodiment, an energy threshold may include an energy value below which the aircraft can no longer support a vertical transition out of landing. For the purposes of this disclosure, a “vertical transition out of landing” is a maneuver conducted as part of or after an aborted landing, wherein vertical propulsors are used to generate lift and move the aircraft in a vertical direction.

In some embodiments, the processor(s) 206 may be configured to determine one or more threshold value(s) for one or more category(ies) of flight 222. For instance, the processor(s) 206 may determine a first threshold value representing a first energy value (e.g., a value below which the aircraft can no longer support a rejected landing, an energy value below which the aircraft can no longer support hover and/or an energy value below which the aircraft can no longer support a vertical transition out of landing). In some embodiments, a second threshold value may include an energy value below which the aircraft can no longer support level flight, an energy value below which the aircraft can no longer support a rejected landing, and/or an energy value below which the aircraft can no longer support level flight.

In an example, the processor(s) 206 may determine the threshold value(s) 224 for each category of flight 222 based on one or more of temperature data 220, weather data 226, and/or weight data 228. As a non-limiting example, increased lift may be required to conduct maneuvers if weight data 228 is higher, thus an increased weight datum may result in higher values for one or more threshold value(s) 224 associated with a particular category of flight. As a non-limiting example, decreased lift may be required to conduct maneuvers if weight data 228 is lower, thus a decreased weight datum may result in lower threshold value(s) 224. Additionally or alternatively, weather data 226 indicating headwinds may correspond to a higher threshold value, below which the aircraft can no longer support level flight. As a non-limiting example, weather data 226 indicating tailwinds may result in a lower threshold value, below which the aircraft can no longer support level flight.

In an example, the processor(s) 206 may determine threshold value(s) 224 using a threshold lookup table. Threshold lookup table may correlate one or more parameters to one or more of the energy threshold values disclosed in this disclosure. As a non-limiting example, threshold look up table may correlate battery temperature data 220 to one or more of the energy threshold values disclosed in this disclosure. As a non-limiting example, threshold look up table may correlate temperature data 220, weight data 228, and/or weather data 226 to one or more of the threshold values 224 disclosed in this disclosure.

In an example, the processor(s) 206 may be configured to generate and output a user interface to display 230. For instance, as described in greater detail below, the interface may comprise one or more display element(s) that may be visual representations of battery data, one or more threshold value(s) 224, temperature data 220, power data 218, useable energy data 216, or any other data described herein. In some embodiments, the display 230 may represent a pilot display. A “pilot display,” for the purposes of this disclosure is a screen that is configured to display data to a pilot. Pilot display may include an LCD screen, LED screen, OLED screen, CRT screen, IPS screen, plasma screen, and the like.

As illustrated, the computing device 204 may include memory 208. As noted above, memory 208 may be communicatively connected to the processor(s) and may comprise instructions configuring processor(s) to perform actions consistent with this disclosure. In an example, memory 208 may store model(s) 210. The model(s) 210 may be generated by the processor(s) 206, stored, and maintained in the memory 208. In an example, the model(s) 210 may comprise machine learned models. In an example, the processor(s) 206 may be configured to generate one or more of the electrical output data 212, energy data 214, useable energy data 216, power data 218, temperature data 220, weather data 226, weight data 228, threshold value(s) 224 using the model(s) 210, such as an artificial intelligence model. In an example, the processor(s) 206 may be configured to utilize the model(s) to generate predicted value(s), threshold value(s) 224 and/or any other feature of the power determination system 104 described herein.

In some examples, the artificial intelligence models are pre-trained using machine learning techniques. In some examples, the power determination system 104 may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as large language model(s) (LLM), small language model(s) (SLM), convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the model(s) 210 may be updated and/or re-trained in real-time. For instance, the processor(s) 206 may update the one or more machine learning models based on pilot input(s) to the display, aircraft data, and/or any data described herein.

FIGS. 3A and 3B depict an example pilot interface 300 implementing components of the power determination system 104, according to examples described herein. In an example, the pilot interface 300 may be included in a cock pit of the aircraft 100. In an example, the pilot interface 300 may correspond to the computing device 204 and/or flight controller described herein.

As illustrated in FIG. 3A, the pilot interface 300 may comprise one or more display(s) 302. A first display 302(1) may comprise a plurality of portions. For instance, portion 1 304 may correspond to a portion of the first display 302(1). In an example, the one or more display(s) 302 may comprise pilot display(s), as described herein. Portion X 306 may correspond to another display and/or portion of the pilot interface 300 and is described in greater detail in FIG. 3B below.

As illustrated in FIG. 3A, the pilot interface 300 may include display element(s) 308(1), 308(2), 308(3), etc. Each display element may comprise visual representations of real-time data and may be dynamically updated. For instance, display element 308(1) may comprise graphical (e.g., visual) representations of data associated with a pusher, such as torque data, motor data, inverter data, temperature, etc. Display element 308(2) may comprise graphical representations of battery data, such as the data described in FIG. 2 above. Display element 308(3) may comprise graphical (e.g., visual) representations of data including yaw, pitch, roll, etc. One or more additional or alternative display element(s) may be included as part of the display 302. In an example, the display 302 may be configured to receive input from the pilot or other user and may update to display representations of updated data, additional data, or alternative data. Display element(s) may also include a power allocation element 310. In an example, the power allocation element 310 may comprise visual representations of real-time connection(s) and usage of battery pack(s) 112 and components of the aircraft. For instance, the power allocation element 310 may display where power from each battery pack is being sent, which component(s) are receiving input, which component(s) are providing electrical output, an amount of power being input/output, etc. In an example, the power allocation element 310 may display electrical data associated with portion X 306 of the pilot interface.

FIG. 3B illustrates an exemplary portion of pilot interface 300. In the illustrated example, portion X 306, noted in FIG. 3B above is illustrated. In an example and as illustrated in FIG. 3B, portion X 306 may comprise visual representations of one or more batteries 312. For instance, 312(1) may correspond to a first battery, 312(2) may correspond to a second battery, 312(3) may correspond to a third battery, 312(4) may correspond to a fourth battery, and 312(5) may correspond to a fifth battery. In an example, each battery 312 may represent a different battery pack 112. In an example, additional or alternative battery packs may be included or represented on the pilot interface.

Portion X 306 may further comprise one or more switches 314. A first switch 314(1) may be connected to one or more of the battery pack(s) (e.g., such as first battery pack 312(1). In the “on” position, the first switch 314(1) may be configured to draft power from the first battery 312(1), the second switch 314(2) may be configured to draw power from the second battery 312(2), the third switch 314(3) may be configured to draw power from the third battery 312(3), the fourth switch 314(2) may be configured to draw power from the fourth battery 312(4), and the fifth switch 314(5) may be configured to draw power from the fifth battery 312(5). In the “off” positions, the switches 314 may not draw power from the batteries. The switches 314 may be moved between the “on” and “off” positions by a pilot. In an embodiment, the flight controller may be configured to cause the switches to move between the “on” and “off” positions.

Portion X 306 further includes second switches 316, which may be configured to control power input and output to DC/DC A 318(1) and/or DC/DC B 318(2). In an example, the DC/DC A 318(1) represents a direct current (DC) to DC converter that an electronic circuit or electromechanical device that converts a source of direct current (DC) from one voltage level to another. For instance, DC/DC A 318(1) and/or DC/DC B 318(2) may be configured to convert power from a high voltage to a low voltage, such as to and from LV Bat 322 (e.g., a low voltage battery/battery pack). A third switch 320 may be configured to control input and output from LV Bat 322 and/or LV backup bat 324 (e.g., a low voltage backup battery). The second switches 316 and third switch 320 may be moved between the “on” and “off” positions by a pilot and/or automatically by the flight controller. In an example, one or more of the high voltage batteries may provide power to an engine and/or DC/DC converters. Thus, stored energy from the high voltage batteries may be provided directly to the engine to provide propulsion, and is also converted into low voltage energy for the electrical system. The DC/DC converters may provide input to one or more of the low voltage battery, aircraft electrical systems, and or flight controls. In an example, the low voltage battery may provide input (e.g., power) to the flight control(s) and/or the aircraft electrical systems.

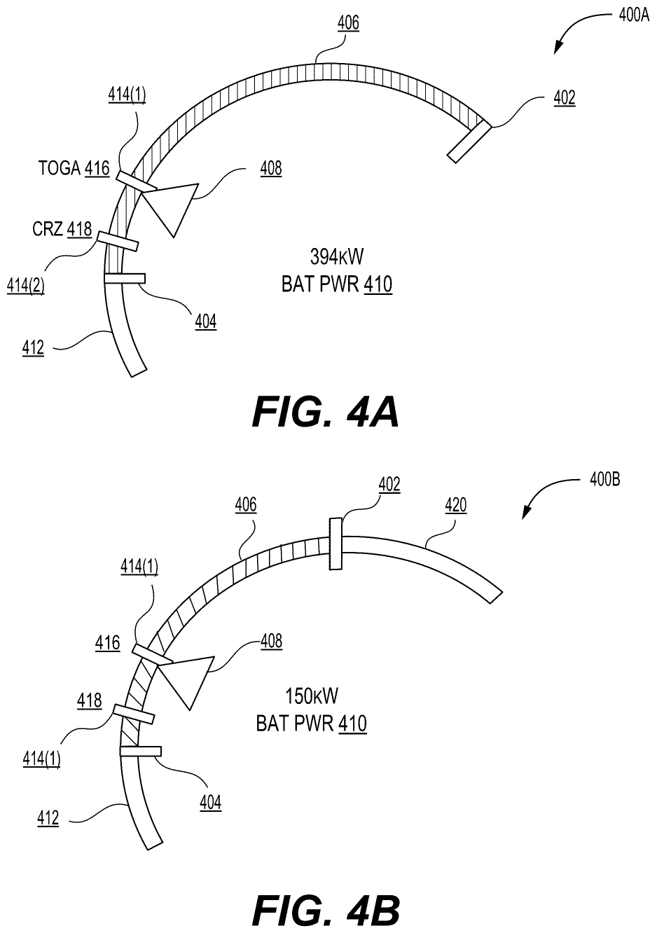

FIGS. 4A and 4B illustrate exemplary display elements 400A and 400B, according to at least one example. For instance, display element 400A and/or display element 400B may correspond to display element(s) 308 described herein.

As illustrated in FIG. 4A, the display element 400A may comprise energy data. For instance, the display element 400A may include a first indicator 402 that represents an amount of usable batter power available to the aircraft 100 and/or a present power consumption capability of the aircraft 100. A second indicator 404 may indicate a threshold value that, below which is a negative power range 412. In an embodiment, the portion 406 of the display element 400A between the first indicator 402 and the second indicator 404 may be highlighted to indicate an alert level. For instance, the portion 406 may be displayed in a color, shading, flashing, or any other suitable indicator or alert. In an example, such as where there is sufficient power to perform flight maneuvers, the portion 406 may be displayed as green, indicating that a threshold level has not been reached. Where a first value is reached, the portion 406 may change to yellow, such that the display element indicates that the aircraft has sufficient power to perform a “go-around” or balked landing (e.g., such as for wing born flight) and/or that the aircraft can no longer support “go-around” landings (e.g., such as for thrust born flight). Where a second threshold value is reached, the portion 406 may be updated and presented as red, indicating that “hover” is no longer supported and/or that the aircraft can no longer support level flight on the wing.

The display element 400A may include a digital indicator 410. The digital indicator 410 may comprise a digital power readout of energy data. For instance, the digital indicator 410 may display a value of the current amount of energy being drawn from one or more batteries, which is also displayed by a third indicator 408. In an example, as the third indicator 408 moves and/or changes, the value displayed by the digital indicator 410 may also dynamically update to match the movement and/or change.

The display element 400A may include reference marker(s) 414. A first reference marker 414(1) may be associated with an amount of power (e.g., pusher Torque in kW) required to perform take-off and/or go-around (TOGA 416). The second reference marker 414(2) may be associated with an amount of power (e.g., Torque in kW) required to perform normal cruise operations for the aircraft (CRZ 418).

FIG. 4B illustrates an exemplary display element 400B that includes the components of display element 400A. In the illustrated example, the display element 400B of FIG. 4B may represent where the first indicator 402 associated with the present power consumption capability of the aircraft has changed, resulting in an updated value displayed by the digital indicator 410. Additionally, the display element 400B includes an unusable power range 420 in addition to the negative power range 412. In an example, the first indicator 402 may be associated and/or represent an amount of energy remaining and/or useable in the battery packs 112, as determined by the power determination system 104.

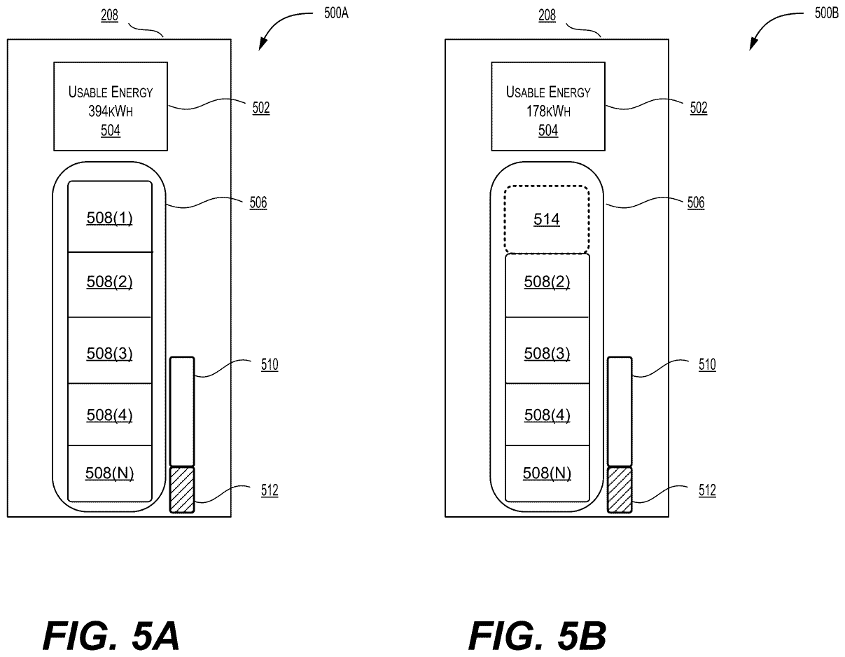

FIGS. 5A and 5B illustrate exemplary display elements 500A and 500B, according to at least one example. For instance, the display elements 500A and/or 500B may correspond to one or more of display element(s) 308 described herein.

As illustrated in FIG. 5A, the display element 500A may include a visual indicator 502. The visual indicator 502 may comprise a representation 504 including value(s) and/or text of energy data. For instance, the representation 504 may comprise a value and text indicating an amount of “useable energy” corresponding to the battery pack(s) 112. In an example, the visual indicator 502 may comprise value(s) associated with useable energy data 216 determined by the computing device 204. In an example, the visual indicator and/or display element 308 may be dynamically updated based on changes in the amount of useable energy, battery pack(s) 112, etc.

As illustrated in FIG. 5A, the display element 500A may include a battery meter 506. For the purposes of this disclosure, “battery meter,” is a graphical illustration of energy of a battery pack or battery pack(s) 112. In some embodiments, battery meter 506 may be in the shape of a battery. In some embodiments, battery meter 506 may include energy data, which may be represented as one or more of a bar, arrow, or other indicator. The battery meter 506 may graphically depict the energy data compared to total energy capacity of a battery pack and/or a plurality of battery pack(s) 112. For instance, the battery meter 506 may include segments 508(1)-508(N), where each segment is associated with a separate battery pack 112. In some embodiments, the number of segments 508 may equal the number of battery packs 112 in the aircraft 100. In some embodiments, each segment may be sized to represent energy data of a particular battery pack 112 to which the segment corresponds. In some embodiments, segments 508(1)-508(N) may be displayed stacked next to one another (vertically or horizontally). The segment(s) 508(1)-508(N) may, when taken together, represent the energy remaining in all of battery packs 112.

As illustrated in FIG. 5A, the display element 500A may include indicator bars 510 and 512. The indicator bars 510 and 512 may be associated with different threshold value(s) and/or one or more categories of flight. For instance, indicator bar 510 may correspond to a threshold value that, when reached, indicates there is 30 minutes remaining at which the aircraft can remain in normal cruise mode. Indicator bar 512 may correspond to a threshold value that, when reached, indicates the aircraft may be unable to maintain normal cruise operations. In an embodiment, the indicator bars 510 and 512 may be associated with reference markers 414(1) and/or 414(2) described in FIGS. 4A and 4B herein. In an example, the indicator bars 510 and 512 may be different sizes based on a category of flight. For instance, indicator bar 510 may be larger and/or smaller based on whether the aircraft is operating in wing born flight or thrust born flight. In an example, additional indicator bars 510 and 512 may be displayed as part of display element 500. The additional indicator bard may illustrate threshold value(s) associated with different categories of flight (e.g., such as conventional take-off and landing, etc.) and may be displayed on an opposing side of the battery meter 506 and/or next to indicator bard 510 and 512.

FIG. 5B an exemplary display element 500B, where a battery pack 112 is offline. As illustrated the display element 500B may comprise battery meter 506. The battery meter 506 may include segment(s) 508, however, a first segment 508(1) may no longer be displayed (illustrated with dashed lines 514 representing the removal of the segment 508(1)). In this example, the segment 508(1) may be removed in response to a pilot switching power to a first battery pack from “on” to “off”, as described herein. Accordingly, 514 may represent the first segment 508(1) of a first battery pack 112 that is offline.

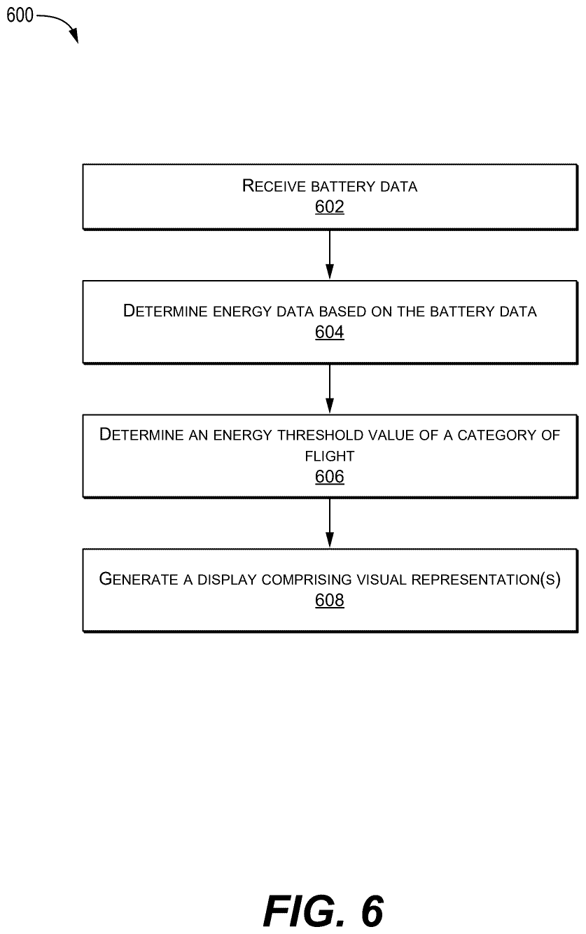

FIG. 6 illustrates a flow diagram of an example system 600 for power determination and indication, according to the techniques described herein. In some instances, one or more of the steps of system 600 may be performed by one or more devices (e.g., computing device 204, flight controller, processor(s), etc.) that include one or more processors and one or more non-transitory computer-readable media storing computer-executable instructions that, when executed by the one or more processors, cause the one or more processors to perform operations of system 600.

At 602, the system may receive battery data. For instance, the system may receive battery data as an input (e.g., input(s) 202 described in FIG. 2 herein). In an example, the system may receive the battery data from at least one battery sensor, the at least one battery sensor being communicatively connected to at least on battery pack and configured to detect battery data.

At 604, the system may determine energy data based on the battery data. In an example, the energy data comprises a useable energy remaining data, wherein the useable energy remaining data is based on the one or more capabilities of the at least one battery pack or a power level associated with the state of health of the at least one battery pack.

At 606, the system may determine an energy threshold value of a category of flight. For instance, the system may determine the energy threshold value based on the energy data and the battery data. In an example, the category of flight comprises thrust born flight or wing born flight. In an example, the energy threshold value is dynamic and determined based on one or more capabilities of the at least one battery pack, the one or more capabilities corresponding to a state of health of the at least one battery pack.

In an example, the energy threshold value is further based in part on a mode of flight of the aircraft, the mode of flight being one of a plurality of modes of flight, and wherein each respective mode of flight corresponds to a respective level of power consumption. For instance, a mode of flight may correspond to a category of flight and/or a portion of a flight plan (e.g., take-off, landing, hover, etc.).

In an example, the system may include memory the memory contains instructions further configuring the at least one processor to receive a weather data; and determine the energy threshold value based on the weather data. Additionally or alternatively, the memory may contain instructions configuring the at least one processor to receive weight data and determine the energy threshold value based on the weight data.

In an example, the memory contains instructions further configuring the at least one processor to determine a second energy threshold value of the category of flight.

At 608, the system may generate a display comprising visual representation(s). For instance, the display may include visual representation(s) of the battery data and/or the energy threshold value. In an example, the display further comprises a battery meter and a flight category threshold associated with the category of flight. For instance, the flight category threshold may correspond to a threshold value 224 as described herein.

In an example, the system may comprise at least one battery pack. The at least one battery pack may comprise a single battery pack or a plurality of battery packs. In an example, the display may further comprise a visual representation of a battery meter comprising a plurality of segments, wherein each segment of the plurality of segments corresponds to a battery pack of the plurality of battery packs.

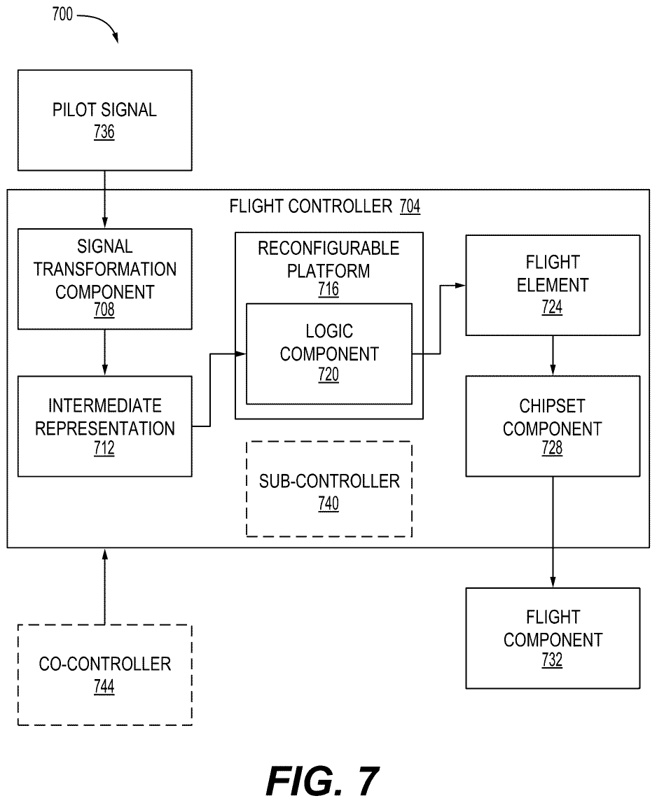

FIG. 7 illustrates an exemplary embodiment 700 of a flight controller 704. As used in this disclosure a “flight controller” is a computing device of a plurality of computing devices dedicated to data storage, security, distribution of traffic for load balancing, and flight instruction. Flight controller 704 may include and/or communicate with any computing device as described in this disclosure, including without limitation a microcontroller, microprocessor, digital signal processor (DSP) and/or system on a chip (SoC) as described in this disclosure. Further, flight controller 704 may include a single computing device operating independently, or may include two or more computing device operating in concert, in parallel, sequentially or the like; two or more computing devices may be included together in a single computing device or in two or more computing devices. In embodiments, flight controller 704 may be installed in an aircraft, may control the aircraft remotely, and/or may include an element installed in the aircraft and a remote element in communication therewith.

In an embodiment, and still referring to FIG. 7, flight controller 704 may include a signal transformation component 708. As used in this disclosure a “signal transformation component” is a component that transforms and/or converts a first signal to a second signal, wherein a signal may include one or more digital and/or analog signals. For example, and without limitation, signal transformation component 708 may be configured to perform one or more operations such as preprocessing, lexical analysis, parsing, semantic analysis, and the like thereof. In an embodiment, and without limitation, signal transformation component 708 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 708 may include transforming one or more low-level languages such as, but not limited to, machine languages and/or assembly languages. For example, and without limitation, signal transformation component 708 may include transforming a binary language signal to an assembly language signal. In an embodiment, and without limitation, signal transformation component 708 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 7, signal transformation component 708 may be configured to optimize an intermediate representation 712. As used in this disclosure an “intermediate representation” is a data structure and/or code that represents the input signal. Signal transformation component 708 may optimize intermediate representation as a function of a data-flow analysis, dependence analysis, alias analysis, pointer analysis, escape analysis, and the like thereof. In an embodiment, and without limitation, signal transformation component 708 may optimize intermediate representation 712 as a function of one or more inline expansions, dead code eliminations, constant propagation, loop transformations, and/or automatic parallelization functions. In another embodiment, signal transformation component 708 may optimize intermediate representation as a function of a machine dependent optimization such as a peephole optimization, wherein a peephole optimization may rewrite short sequences of code into more efficient sequences of code. Signal transformation component 708 may optimize intermediate representation to generate an output language, wherein an “output language,” as used herein, is the native machine language of flight controller 704. For example, and without limitation, native machine language may include one or more binary and/or numerical languages.

In an embodiment, and without limitation, signal transformation component 708 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 7, flight controller 704 may include a reconfigurable hardware platform 716. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 716 may be reconfigured to enact any algorithm and/or algorithm selection process received from another computing device and/or created using machine-learning processes.

Still referring to FIG. 7, reconfigurable hardware platform 716 may include a logic component 720. As used in this disclosure a “logic component” is a component that executes instructions on output language. For example and without limitation, logic component may perform basic arithmetic, logic, controlling, input/output operations, and the like thereof. Logic component 720 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 720 may be organized according to Von Neumann and/or Harvard architecture as a non-limiting example. Logic component 720 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 720 may include one or more integrated circuit microprocessors, which may contain one or more central processing units, central processors, and/or main processors, on a single metal-oxide-semiconductor chip. Logic component 720 may be configured to execute a sequence of stored instructions to be performed on the output language and/or intermediate representation 712. Logic component 720 may be configured to fetch and/or retrieve the instruction from a memory cache, wherein a “memory cache,” as used in this disclosure, is a stored instruction set on flight controller 704. Logic component 720 may be configured to decode the instruction retrieved from the memory cache to opcodes and/or operands. Logic component 720 may be configured to execute the instruction on intermediate representation 712 and/or output language. For example and without limitation, logic component 720 may be configured to execute an addition operation on intermediate representation 712 and/or output language.

In an embodiment, and without limitation, logic component 720 may be configured to calculate a flight element 724. As used in this disclosure a “flight element” is an element of datum denoting a relative status of aircraft. For example, and without limitation, flight element 724 may denote one or more torques, thrusts, airspeed velocities, forces, altitudes, groundspeed velocities, directions during flight, directions facing, forces, orientations, and the like thereof. For example, and without limitation, flight element 724 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 724 may denote that aircraft is following a flight path accurately and/or sufficiently.

Still referring to FIG. 7, flight controller 704 may include a chipset component 728. As used in this disclosure a “chipset component” is a component that manages data flow. In an embodiment, and without limitation, chipset component 728 may include a northbridge data flow path, wherein the northbridge dataflow path may manage data flow from logic component 720 to a high-speed device and/or component, such as a RAM, graphics controller, and the like thereof. In another embodiment, and without limitation, chipset component 728 may include a southbridge data flow path, wherein the southbridge dataflow path may manage data flow from logic component 720 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 728 may manage data flow between logic component 720, memory cache, and a flight component 732. As used in this disclosure a “flight component” is a portion of an aircraft that can be moved or adjusted to affect one or more flight elements. For example, flight component 732 may include a component used to affect the aircrafts' roll and pitch which may comprise one or more ailerons. As a further example, flight component 732 may include a rudder to control yaw of an aircraft. In an embodiment, chipset component 728 may be configured to communicate with a plurality of flight components as a function of flight element 724. For example, and without limitation, chipset component 728 may transmit to an aircraft rotor to reduce torque of a first lift propulsor and increase the forward thrust produced by a pusher component to perform a flight maneuver.

In an embodiment, and still referring to FIG. 7, flight controller 704 may be configured generate an autonomous function. As used in this disclosure an “autonomous function” is a mode and/or function of flight controller 704 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 724. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 704 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 704 will control the ailerons and/or rudders. As used in this disclosure “non-autonomous mode” is a mode that denotes a pilot will control aircraft and/or maneuvers of aircraft in its entirety.

In an embodiment, and still referring to FIG. 7, as used in this disclosure a “pilot signal” is an element of datum representing one or more functions a pilot is controlling and/or adjusting. For example, pilot signal 736 may denote that a pilot is controlling and/or maneuvering ailerons, wherein the pilot is not in control of the rudders and/or propulsors. In an embodiment, pilot signal 736 may include an implicit signal and/or an explicit signal. For example, and without limitation, pilot signal 736 may include an explicit signal, wherein the pilot explicitly states there is a lack of control and/or desire for autonomous function. As a further non-limiting example, pilot signal 736 may include an explicit signal directing flight controller 704 to control and/or maintain a portion of aircraft, a portion of the flight plan, the entire aircraft, and/or the entire flight plan. As a further non-limiting example, pilot signal 736 may include an implicit signal, wherein flight controller 704 detects a lack of control such as by a malfunction, torque alteration, flight path deviation, and the like thereof. In an embodiment, and without limitation, pilot signal 736 may include one or more explicit signals to reduce torque, and/or one or more implicit signals that torque may be reduced due to reduction of airspeed velocity. In an embodiment, and without limitation, pilot signal 736 may include one or more local and/or global signals. For example, and without limitation, pilot signal 736 may include a local signal that is transmitted by a pilot and/or crew member. As a further non-limiting example, pilot signal 736 may include a global signal that is transmitted by air traffic control and/or one or more remote users that are in communication with the pilot of aircraft. In an embodiment, pilot signal 736 may be received as a function of a tri-state bus and/or multiplexor that denotes an explicit pilot signal should be transmitted prior to any implicit or global pilot signal.

Still referring to FIG. 7, flight controller 704 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 7, flight controller 704 may include, but is not limited to, for example, a cluster of flight controllers in a first location and a second flight controller or cluster of flight controllers in a second location. Flight controller 704 may include one or more flight controllers dedicated to data storage, security, distribution of traffic for load balancing, and the like. Flight controller 704 may be configured to distribute one or more computing tasks as described below across a plurality of flight controllers, which may operate in parallel, in series, redundantly, or in any other manner used for distribution of tasks or memory between computing devices. For example, and without limitation, flight controller 704 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 7, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 732. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 7, the plurality of flight controllers may include a primary bus controller. As used in this disclosure a “primary bus controller” is one or more devices and/or components that are connected to a bus to initiate a direct memory access transaction, wherein a bus is one or more terminals in a bus architecture. Primary bus controller may communicate using synchronous and/or asynchronous bus control protocols. In an embodiment, primary bus controller may include flight controller 704. In another embodiment, primary bus controller may include one or more universal asynchronous receiver-transmitters (UART). For example, and without limitation, primary bus controller may include one or more bus architectures that allow a bus to initiate a direct memory access transaction from one or more buses in the bus architectures. As a further non-limiting example, primary bus controller may include one or more peripheral devices and/or components to communicate with another peripheral device and/or component and/or the primary bus controller. In an embodiment, primary bus controller may be configured to perform bus arbitration. As used in this disclosure “bus arbitration” is method and/or scheme to prevent multiple buses from attempting to communicate with and/or connect to primary bus controller. For example and without limitation, bus arbitration may include one or more schemes such as a small computer interface system, wherein a small computer interface system is a set of standards for physical connecting and transferring data between peripheral devices and primary bus controller by defining commands, protocols, electrical, optical, and/or logical interfaces. In an embodiment, primary bus controller may receive intermediate representation 712 and/or output language from logic component 720, wherein output language may include one or more analog-to-digital conversions, low bit rate transmissions, message encryptions, digital signals, binary signals, logic signals, analog signals, and the like thereof described above in detail.

Still referring to FIG. 7, the primary bus controller may communicate with a secondary bus. As used in this disclosure a “secondary bus” is one or more peripheral devices and/or components that initiate a bus transfer. For example, and without limitation, secondary bus may receive one or more controls and/or asymmetric communications from primary bus controller, wherein secondary bus transfers data stored to primary bus controller. In an embodiment, and without limitation, secondary bus may include one or more internal buses, such as but not limited to a/an internal data bus, memory bus, system bus, front-side bus, and the like thereof. In another embodiment, and without limitation, secondary bus may include one or more external buses such as external flight controllers, external computers, remote devices, printers, aircraft computer systems, flight control systems, and the like thereof.

In an embodiment, and still referring to FIG. 7, control algorithm may optimize signal communication as a function of determining one or more discrete timings. For example, and without limitation primary bus controller may synchronize timing of the segmented control algorithm by injecting high priority timing signals on a bus of the primary bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 7, flight controller 704 may also be implemented using a “shared nothing” architecture in which data is cached at the worker, in an embodiment, this may enable scalability of aircraft and/or computing device. Flight controller 704 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, a node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

Still referring to FIG. 7, flight controller may include a sub-controller 740. As used in this disclosure a “sub-controller” is a controller and/or component that is part of a distributed controller as described above; for instance, flight controller 704 may be and/or include a distributed flight controller made up of one or more sub-controllers. For example, and without limitation, sub-controller 740 may include any controllers and/or components thereof that are similar to distributed flight controller and/or flight controller as described above. Sub-controller 740 may include any component of any flight controller as described above. Sub-controller 740 may be implemented in any manner suitable for implementation of a flight controller as described above. As a further non-limiting example, sub-controller 740 may include one or more processors, logic components and/or computing devices capable of receiving, processing, and/or transmitting data across the distributed flight controller as described above. As a further non-limiting example, sub-controller 740 may include a controller that receives a signal from a first flight controller and/or first distributed flight controller component and transmits the signal to a plurality of additional sub-controllers and/or flight components.

Still referring to FIG. 7, flight controller may include a co-controller 744. As used in this disclosure a “co-controller” is a controller and/or component that joins flight controller 704 as components and/or nodes of a distributer flight controller as described above. For example, and without limitation, co-controller 744 may include one or more controllers and/or components that are similar to flight controller 704. As a further non-limiting example, co-controller 744 may include any controller and/or component that joins flight controller 704 to distributer flight controller. As a further non-limiting example, co-controller 744 may include one or more processors, logic components and/or computing devices capable of receiving, processing, and/or transmitting data to and/or from flight controller 704 to distributed flight control system. Co-controller 744 may include any component of any flight controller as described above. Co-controller 744 may be implemented in any manner suitable for implementation of a flight controller as described above.

In an embodiment, and with continued reference to FIG. 7, flight controller 704 may be designed and/or configured to perform any method, method step, or sequence of method steps in any embodiment described in this disclosure, in any order and with any degree of repetition. For instance, flight controller 704 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

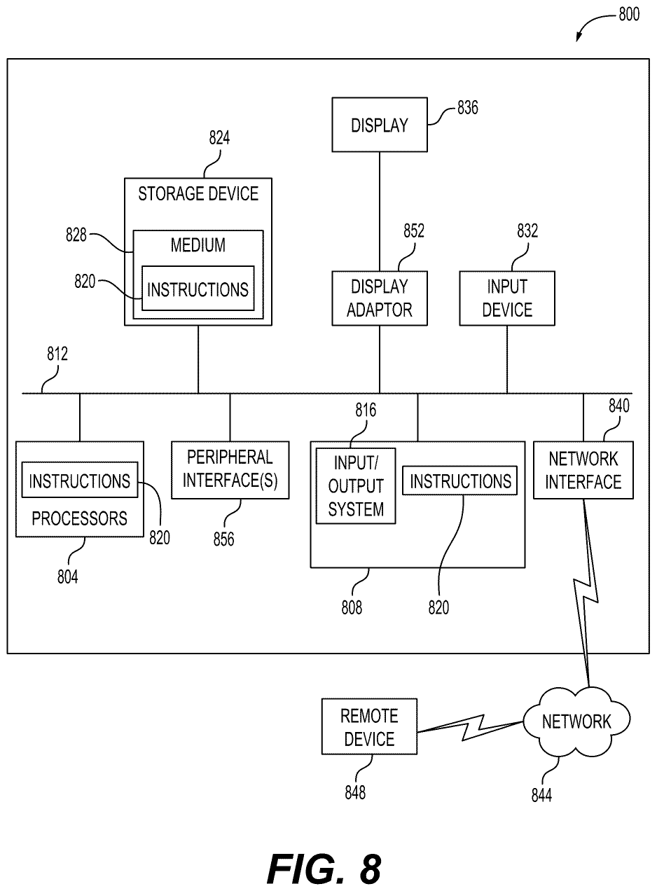

FIG. 8 illustrates a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1384 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display 836. Examples of a display device include, but are not limited to, a liquid crystal display (LCD), a cathode ray tube (CRT), a plasma display, a light emitting diode (LED) display, and any combinations thereof. Display adapter 852 and display 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

### CONCLUSION

While one or more examples of the techniques described herein have been described, various alterations, additions, permutations, and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Additionally, those having ordinary skill in the art readily recognize that the techniques described above can be used in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this description.

What is claimed is:

1. A system for energy requirement determination of an aircraft, the system comprising:
at least one battery pack;
at least one battery sensor, wherein the at least one battery sensor is communicatively connected to the at least one battery pack and configured to detect battery data;
at least one processor; and
a memory communicatively connected to the at least one processor, the memory containing instructions configuring the at least one processor to:
receive the battery data from the at least one battery sensor;
determine energy data based on the battery data;
determine, based on the energy data and the battery data, an energy threshold value of a category of flight; and
generate a display comprising visual representations of the battery data and the energy threshold value.

2. The system of claim 1, wherein the category of flight comprises thrust born flight or wing born flight.

3. The system of claim 1, wherein the energy threshold value is dynamic and determined based on one or more capabilities of the at least one battery pack, the one or more capabilities corresponding to a state of health of the at least one battery pack.

4. The system of claim 3, wherein the energy data comprises a useable energy remaining data, wherein the useable energy remaining data is based on the one or more capabilities of the at least one battery pack or a power level associated with the state of health of the at least one battery pack.

5. The system of claim 1, wherein the energy threshold value is further based in part on a mode of flight of the aircraft, the mode of flight being one of a plurality of modes of flight, and wherein each respective mode of flight corresponds to a respective level of power consumption.

6. The system of claim 1, wherein the memory contains instructions further configuring the at least one processor to:
receive weather data; and
determine the energy threshold value based on the weather data.

7. The system of claim 1, wherein the memory contains instructions further configuring the at least one processor to:
receive weight data; and
determine the energy threshold value based on the weight data.

8. The system of claim 1, wherein:
the at least one battery pack comprises a plurality of battery packs; and
the display further comprises a battery meter comprising a plurality of segments, wherein each segment of the plurality of segments corresponds to a battery pack of the plurality of battery packs.

9. The system of claim 1, wherein the memory contains instructions further configuring the at least one processor to determine a second energy threshold value of the category of flight.

10. The system of claim 1, wherein the display further comprises a battery meter and a flight category threshold associated with the category of flight.

11. A method for energy requirement determination of an aircraft, the method comprising:
detecting, by a battery sensor communicatively connected to a battery pack, battery data;
receiving, by a processor, the battery data from the battery sensor;
determining, by the processor, an energy data based on the battery data;
determining, by the processor and based on the energy data and the battery data, an energy threshold value of a category of flight; and
generating, by the processor, a display comprising visual representations of the battery data and the energy threshold value.

12. The method of claim 11, wherein the category of flight comprises thrust born flight or wing born flight.

13. The method of claim 11, wherein the energy threshold value is dynamic and determined based on one or more capabilities of the battery pack, the one or more capabilities corresponding to a state of health of the battery pack.

14. The method of claim 13, wherein the energy data comprises a useable energy remaining data, wherein the useable energy remaining data is based on the one or more capabilities of the battery pack or a power level associated with the state of health of the battery pack.

15. The method of claim 11, wherein the energy threshold value is further based in part on a mode of flight of the aircraft, the mode of flight being one of a plurality of modes of flight, and wherein each respective mode of flight corresponds to a respective level of power consumption.

16. The method of claim 11, further comprising:
receiving, by the processor, weather data; and
determining, by the processor, the energy threshold value based on the weather data.

17. The method of claim 11, further comprising:
receiving, by the processor, weight data; and
determining, by the processor, the energy threshold value based on the weight data.

18. The method of claim 11, wherein:
the battery pack comprises a plurality of battery packs; and
the display comprises a battery meter comprising a plurality of segments, wherein each segment of the plurality of segments corresponds to a respective battery pack of the plurality of battery packs.

19. The method of claim 11, further comprising determining, by the processor, a second energy threshold value of the category of flight.

20. The method of claim 11, wherein the display comprises a battery meter and a flight category threshold associated with the energy threshold value.
